(19) United States
(12) Patent Application Publication
(10) Pub. No.: US 2006/0259932 A1
(43) Pub. Date: Nov. 16, 2006

(54) Data broadcast receiver, and apparatus and method for displaying data broadcast contents in the data broadcast receiver

(75) Inventors: Yang-soo Kim, Seoul (KR); Kwang-kee Lee, Seoul (KR); Sung-jin Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/409,074

(22) Filed: Apr. 24, 2006

Related U.S. Application Data
(60) Provisional application No. 60/679,247, filed on May 10, 2005.

(30) Foreign Application Priority Data
Jun. 3, 2005 (KR) 10-2005-0048005

(51) Int. Cl. H04N 7/173; G06F 13/00; H04N 7/16; H04N 5/445; G06F 3/00

(52) U.S. Cl. 725/100; 725/131; 725/139; 725/38

(57) ABSTRACT

A data broadcast receiver, and an apparatus and method of displaying data broadcast contents in the data broadcast receiver, where the method includes: receiving application contents for a data broadcast; obtaining system information of the data broadcast receiver; reconstructing the application contents on the basis of the system information; and displaying the reconstructed application contents. Therefore, it is possible to display and execute application contents without causing user confusion in a data broadcast service.

### CROSS-REFERENCE TO RELATED PATENT APPLICATIONS

This application claims priority from U.S. Patent Application No. 60/679,247, filed on May 10, 2005, in the United States Patent and Trademark Office, and Korean Patent Application No. 10-2005-0048005, filed on Jun. 3, 2005, in the Korean Intellectual Property Office, the disclosures of which are incorporated herein in their entireties by reference.

### BACKGROUND OF THE INVENTION

1. Field of the Invention

The present invention relates to a data broadcast receiver, and an apparatus and method for displaying data broadcast contents in the data broadcast receiver.

2. Description of the Related Art

Digital data broadcast receivers that receive television broadcast signals in which images are digitized and transmitted through ground waves, satellites, cables, etc., are becoming more widely available. Digital data broadcast receivers provide many channels so that various programs can be provided to users, and also provide various application contents so that interactive information and various other information can be provided to users. In order to select and execute functions provided from such application contents, a remote controller of a data broadcast receiver includes color keys, etc. for selecting functions and the application contents also have a function key menu for selecting the functions. However, generally, because remote controllers are manufactured by manufacturers of broadcast receivers and application contents are produced by different content producers, confusion will occur if the receiver manufacturers and the content producers do not manufacture their respective products under the same specifications.

FIG. 1 is an example of a remote controller 100 used in a conventional data broadcast receiver. In the remote controller 100, color keys 110 which are additional function keys defined in the data broadcast middleware standard are arranged in an order of red (R), green (G), yellow (Y) and blue (B). The colors, shapes and arrangement order of the respective color keys 110 of the remote controller 100 can be mapped and decided by designers, etc. of a manufacturing company of the corresponding conventional receiver.

FIG. 2 is an example of a screen 200 displayed on a display unit of a conventional data broadcast receiver. The screen 200 includes a window 210 displaying video data received by a data broadcast, and a part 220 displaying application contents.

In particular, a color key menu 221 for executing functions required for a corresponding application is provided in a predetermined area of the part 220 on which the application contents are displayed. Respective keys of the color key menu 221 are used to select and execute the functions required for the corresponding application. When KeyEvent values corresponding to the respective keys are received, an application contents execution process programmed in the receiver operates according to codes for executing functions corresponding to the KeyEvent values. At this time, the contents recognize the keys in a format of key identification values irrelevant to the actual colors or shapes of the keys, such as HRcEvent.VK_COLORED_KEY_0,HRcEvent.VK_COLORED_KEY_1,HRc Event.VK_COLORED_KEY_2,HRcEvent.VK_COLORED_KEY_3,HRcEvent.VK_COLORED_KEY_4,HRcEvent.VK_COLORED_KEY_5. The colors, shapes and arrangement order of the keys displayed on a user interface of the screen are already set by the contents.

For users' convenience, application contents manufacturers generally set which operation or menu function the user's input will execute when a user selects a color key displayed on a screen of corresponding contents, for example, as illustrated in FIG. 2. As such, a user interface sets the colors of respective color keys according to users' convenience, instead of displaying KeyEvent values for the respective color keys, however, a color definition standard regarding the respective color key values has not yet established and is different according to policies of manufacturing companies.

Therefore, because manufacturing companies of data broadcast receivers and corresponding remote controllers do not yet have a standardized specification regarding color keys, they can arbitrarily decide the colors, arrangement, shapes, etc. of color keys according to their policies when manufacturing remote controllers. Meanwhile, even if data broadcast content producers try to display the same color key arrangement as that of a receiver remote controller on a contents user interface, for viewers' convenience, it is actually difficult to produce application contents suitable for a remote controller environment available to various receivers.

Therefore, content producers have no option but to allow contents to display a statically pre-defined color key arrangement on a user interface, under the assumption that a remote controller has a pre-defined color key arrangement. Accordingly, if a remote controller of a receiver and contents displayed through the receiver use the same color key arrangement method based on the same data broadcast specification, users can select and execute functions of the contents without any confusion. However, if a remote controller of a receiver and contents displayed through the receiver use different color key arrangement methods, users will suffer inconvenience and confusion.

### SUMMARY OF THE INVENTION

The present invention provides a data broadcast receiver, and an apparatus and method for displaying data broadcast contents in the data broadcast receiver, which are capable of allowing users to more conveniently use data application contents displayed on the data broadcast receiver when a data broadcast is received.

According to an aspect of the present invention, there is provided a method of displaying data broadcast contents in a data broadcast receiver, including: receiving application contents of a data broadcast; obtaining system information of the data broadcast receiver; reconstructing the application contents on the basis of the system information; and displaying the reconstructed application contents.

The system information may include information regarding color keys or function keys of a remote controller for providing a user's input to the data broadcast receiver.

The information regarding the color keys or the function keys may comprise at least one of arrangement information, shape information, color information and sound information of the color keys or the function keys.

The reconstruction of the application contents may include mapping the obtained information regarding the color keys or the function keys to information regarding a color key menu or a function key menu of the application contents.

The reconstruction of the application contents may further include setting an arrangement of the color key menu or the function key menu of the application contents to be the same as an arrangement of the color keys or the function keys of the remote controller.

According to another aspect of the present invention, there is provided an apparatus of controlling display of data broadcast contents in a data broadcast receiver, including: a memory receiving and storing application contents of a data broadcast; and a controller loading application contents stored in the memory, obtaining system information of the data broadcast receiver, reconstructing the application contents on the basis of the system information, and executing the reconstructed application contents.

According to another aspect of the present invention, there is provided a method of displaying data broadcast contents in a data broadcast receiver, including: receiving a data broadcast signal; extracting application contents from the data broadcast signal; reconstructing the application contents on the basis of system information of the data broadcast receiver; and displaying the reconstructed application contents.

The reconstruction of the application contents may include: obtaining system information regarding color keys or function keys of a remote controller of the data broadcast receiver; and mapping the system information to information regarding a color key menu or a function key menu of the application contents, and creating mapping information.

The reconstruction of the application contents may further include: changing a user interface of the application contents so that an arrangement of the color key menu or the function key menu of the application contents displayed on a display unit is the same as an arrangement of the color keys or the function keys of the remote controller.

The broadcast content display method may further include executing a corresponding function using the mapping information if predetermined menu selection information for the reconstructed application contents is received from a user.

According to another aspect of the present invention, there is provided a data broadcast receiver, including: a tuner receiving a data broadcast signal; a channel decoder extracting application contents from the data broadcast signal received through the tuner; a controller reconstructing the application contents on the basis of system information of the data broadcast receiver; and a video outputting unit displaying the reconstructed application contents.

### BRIEF DESCRIPTION OF THE DRAWINGS

The above and other features and advantages of the present invention will become more apparent by describing in detail exemplary, non-limiting embodiments thereof with reference to the attached drawings in which:

FIG. 1 is an example of a remote controller used in a conventional data broadcast receiver;

FIG. 2 is an example of a screen displayed on a display unit of a data broadcast receiver;

FIG. 3 is a block diagram of a data broadcast receiver according to a non-limiting embodiment of the present invention;

FIG. 4 is a detailed block diagram of the data broadcast receiver of FIG. 3, according to a non-limiting embodiment of the present invention;

FIGS. 5A through 5D are examples of color keys of a remote controller;

FIGS. 6A through 6E are views for explaining a method of reconstructing application contents, according to a non-limiting embodiment of the present invention;

FIGS. 7A through 7E are views for explaining a method of reconstructing application contents, according to another non-limiting embodiment of the present invention;

FIG. 8 is a flowchart illustrating a method of reconstructing application contents, according to a non-limiting embodiment of the present invention; and

FIG. 9 is a flowchart illustrating a process of executing functions provided by reconstructed application contents, according to a non-limiting embodiment of the present invention.

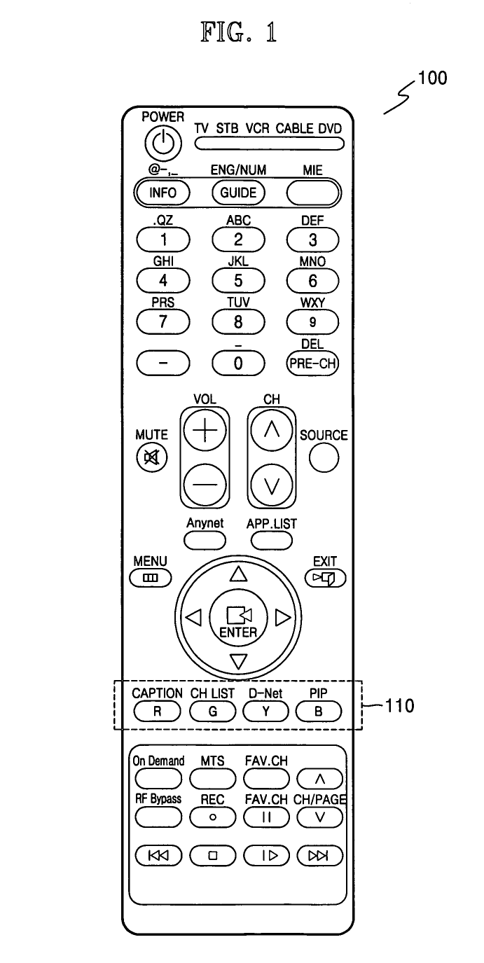

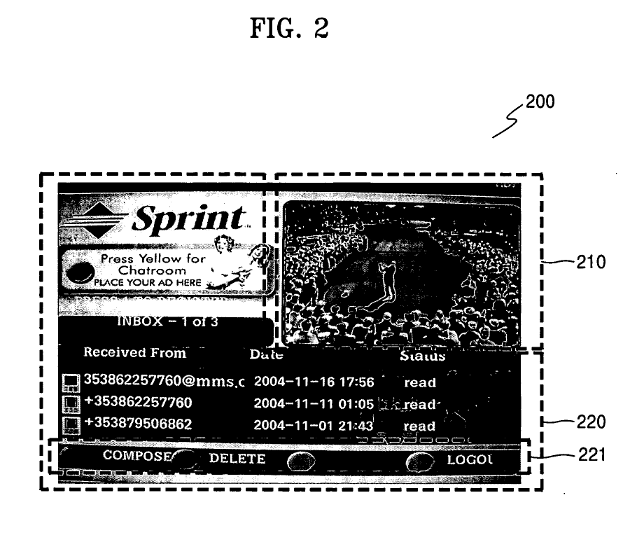

### DETAILED DESCRIPTION OF THE INVENTION

The present invention will now be described more fully with reference to the accompanying drawings, in which exemplary, non-limiting embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their descriptions will not be repeated.

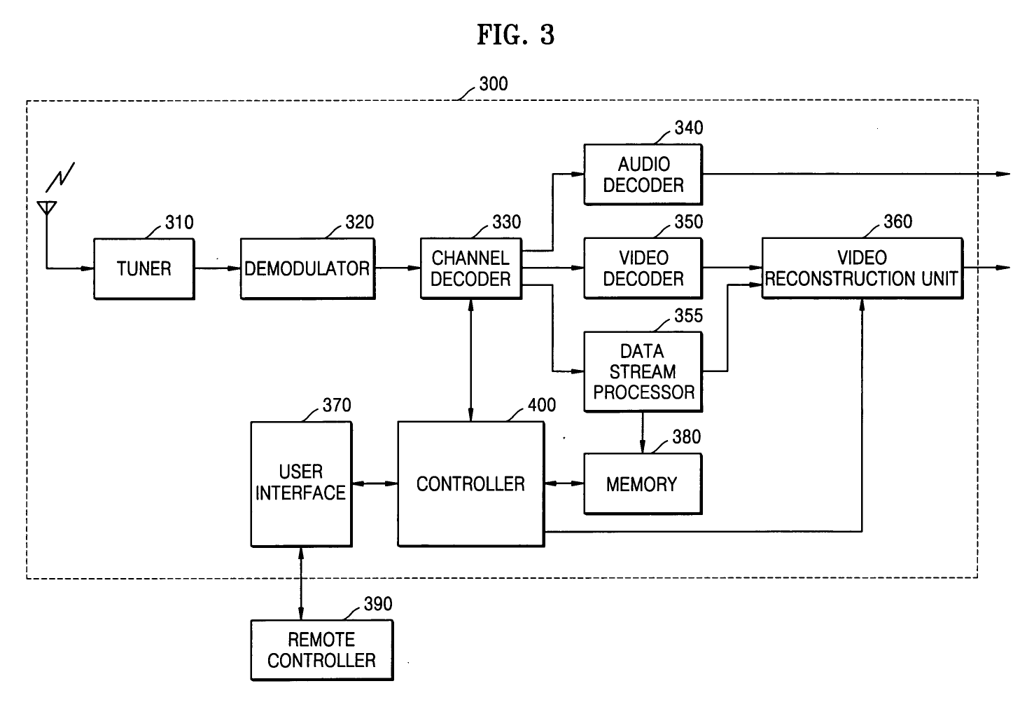

FIG. 3 is a block diagram of a data broadcast receiver 300 according to a non-limiting embodiment of the present invention.

Referring to FIG. 3, the data broadcast receiver 300 includes a tuner 310, a demodulator 320, a channel decoder 330, an audio decoder 340, a video decoder 350, a data stream processor 355, a video reconstruction unit 360, a user interface 370, a memory 380, a remote controller 390, and a controller 400.

The data broadcast receiver 300 receives data broadcast signals including video, audio and application contents through an antenna.

The application contents are produced by a contents producer, and are transmitted by a broadcasting station. In the present invention, the application contents can have an arbitrary format. The application contents may be application contents which allow viewers to purchase products shown in the drama while a video service such as a drama, etc. is being provided; application contents which provide information regarding persons acting in a drama; application contents which allow viewers to choose a viewing angle in sports broadcasting services, etc.; and application contents which services the sending and reception of e-mails or text messages independently from a provided video or audio service.

Each application contents may include function keys or menu keys, etc. to allow the execution or selection of predetermined functions according to a provided application service. The function keys or menu keys correspond to color keys of a remote controller, and content producers produce contents in which the arrangement, shapes, and sounds of the function keys or menu keys can be dynamically created.

The tuner 310 receives a modulated signal and provides it to the demodulator 320. The demodulator 320 demodulates the modulated signal received from the tuner 310, performs error correction, etc. on the demodulated signal, creates digital data in a form of a so-called “transport stream”, and transfers the transport stream to the channel decoder 330.

The channel decoder 330 extracts video data and audio data of a channel selected by user manipulation of the remote controller, etc., from the transport stream in which video, audio, application data, etc. of a plurality of channels are time-division multiplexed. The channel decoder 330 transfers the audio data to the audio decoder 340 and the video data to the video decoder 350. Also, the channel decoder 330 extracts application data from the transport stream and transfers the application data to the data stream processor 355. The data stream processor 355 processes the received application data, and stores the processed application data in the memory 380 or provides the processed application data to the video reconstruction unit 360 so that the application data can be directly displayed.

The audio decoder 340 decodes the audio data output from the channel decoder 330, and the video decoder 350 decodes the video data and provides the decoded video data to a display controller (not shown) so that the video data can be displayed on a screen of a display unit.

The controller 400 controls the respective components included in the receiver 300. Specifically, in order to reconstruct application contents according to the non-limiting embodiment of the present invention, the controller 400 loads application contents stored in the memory 380, reconstructs the application contents so that they are suitable for the display by the receiver 300, executes the reconstructed application contents, and provides the result to the video reconstruction unit 360.

Users can manipulate the remote controller 390 to select a desired channel or a desired function of the application contents. Such channel selection information or function selection information from users is transferred to the controller 400 and the channel decoder 330 through the user interface 370. The channel decoder 330 outputs audio data and video data regarding the selected channel to the audio decoder 340 and the video decoder 350, respectively.

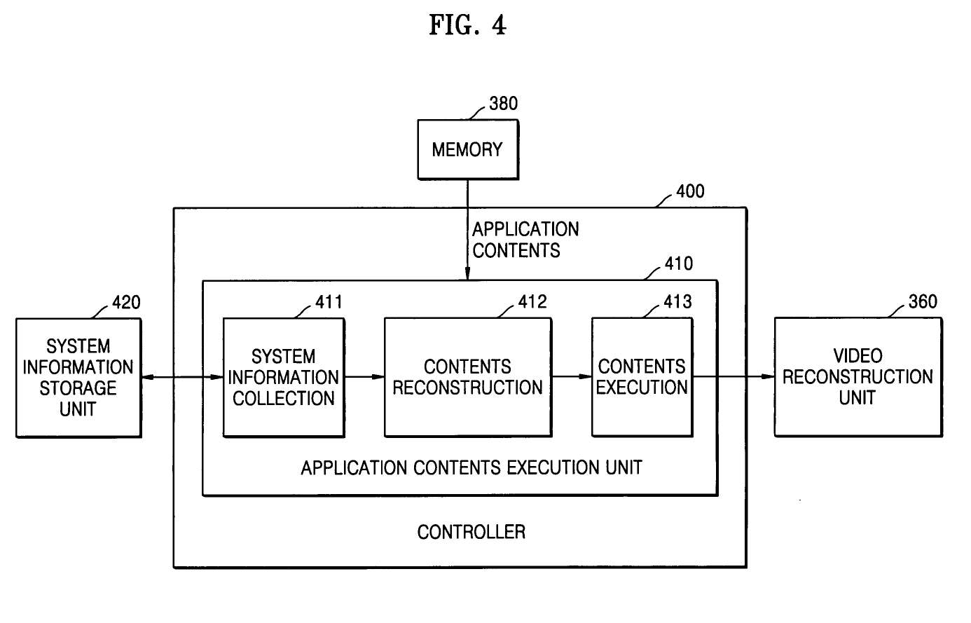

Specifically, as shown in FIG. 4, the controller 400 of the data broadcast receiver 300 according to a non-limiting embodiment of the present invention includes an application contents execution unit 410 for executing received application contents.

A system information storage unit 420 stores system information of the data broadcast receiver 300, specifically, information regarding color keys among system information of the remote controller 390.

The remote controller 390 provides a user input for controlling the functions of the receiver 300 or a user input for selecting at least one of menus or functions displayed on a screen of the receiver 300, to the user interface 370.

The user interface 370 provides a user input received from the remote controller 390 to the controller 400. The controller 400 controls components of the receiver 300 or executes predetermined functions of application contents according to the user input received from the user interface 370.

FIG. 4 is a detailed block diagram of the controller 400 according to a non-limiting embodiment of the present invention.

Referring to FIG. 4, the controller 400 includes the application contents execution unit 410 for reconstructing application contents so that the application contents are suitable for display by the receiver 300 and executing the reconstructed application contents.

Actually, the application contents execution unit 410 conceptually represents a process for executing application contents loaded in the controller 400.

If application contents are loaded from the memory 380, the application contents execution unit 410 sends a command requesting system information to the system information storage unit 420, obtains the system information of the receiver 300 as a response from the system information storage unit 420, and collects the system information. An Application Program Interface (API) can be used to collect the system information.

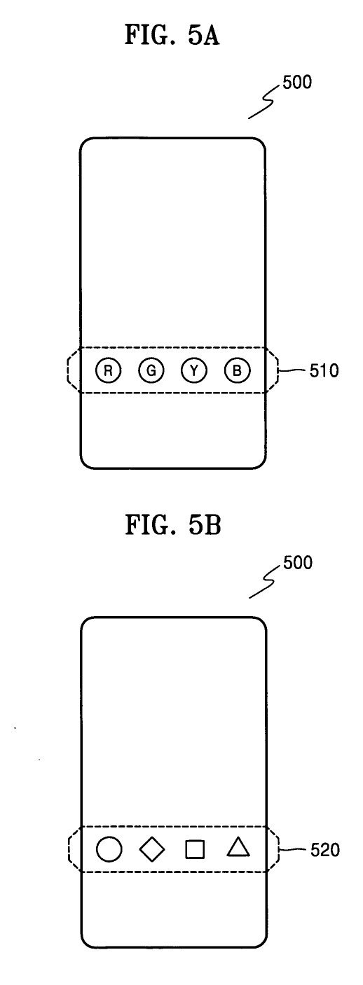

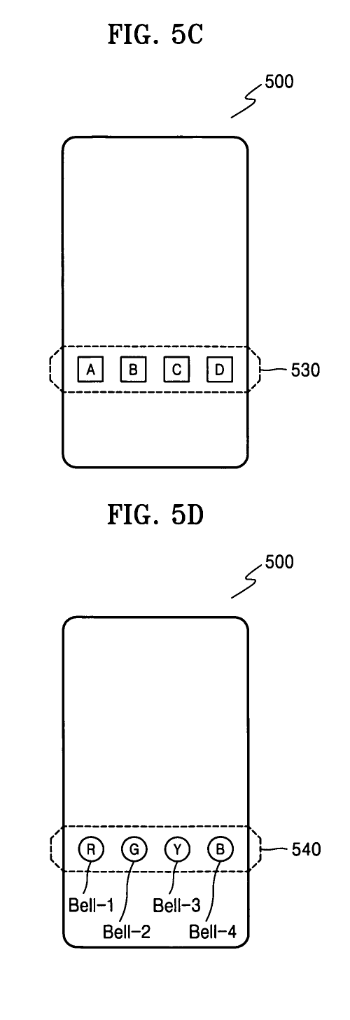

If the system information is collected, the application contents are reconstructed on the basis of the system information. The system information may be key information of the remote controller 390, as illustrated in FIGS. 5A through 5D.

FIG. 5A is an example in which color keys 510 are arranged on a remote controller 500. In the example illustrated in FIG. 5A, the color keys 510 are arranged in an order of a red key, a green key, a yellow key and a blue key. If function key information is requested as system information for system information collection, the function key information can be received in the following format.
pcolor_0=Red,
color_1=Green,
color_2=Yellow,
color_3=Blue

The function key information as illustrated above schematically shows only the contents of the function key information, however, the present invention is not limited to the information format shown above.

FIG. 5B is an example in which shape keys 520 are arranged on the remote controller 500. In the example illustrated in FIG. 5B, the shape keys 520 are arranged in an order of a circle key, a diamond key, a square key, and a triangle key. If function key information is requested as system information for system information collection, the function key information can be received in the following format.
shape_0=circle,
shape_1=diamond,
shape_2=square,
shape_3=triangle

FIG. 5C is an example in which text keys 530 are arranged on the remote controller 500. In the example illustrated in FIG. 5C, the text keys 530 are arranged in an order of an A key, a B key, a C key and a D key. If function key information is requested as system information for system information collection, the function key information can be received in the following format.
text_0=A,
text_1=B,
text_2=C,
text_3=D

FIG. 5D is an example in which color keys 540 are arranged on the remote controller 500 and each color key has a corresponding bell sound. In the example illustrated in FIG. 5D, the color keys 540 are arranged in an order of a red key, a green key, a yellow key and a blue key. If function key information is requested as system information for system information collection, the function key information can be received in the following format.
color_0=R=bell_0,
color_1=G=bell_1,
color_2=Y=bell_2,
color_3=B=bell_3

In the above examples, the red, green, yellow and blue keys which are color keys, the circle, diamond, square and triangle keys which are shape keys, and the A, B, C and D keys which are text keys, are all exemplary, and the invention is not limited to the above-mentioned key types.

Then, the application contents are reconstructed on the basis of the collected system information.

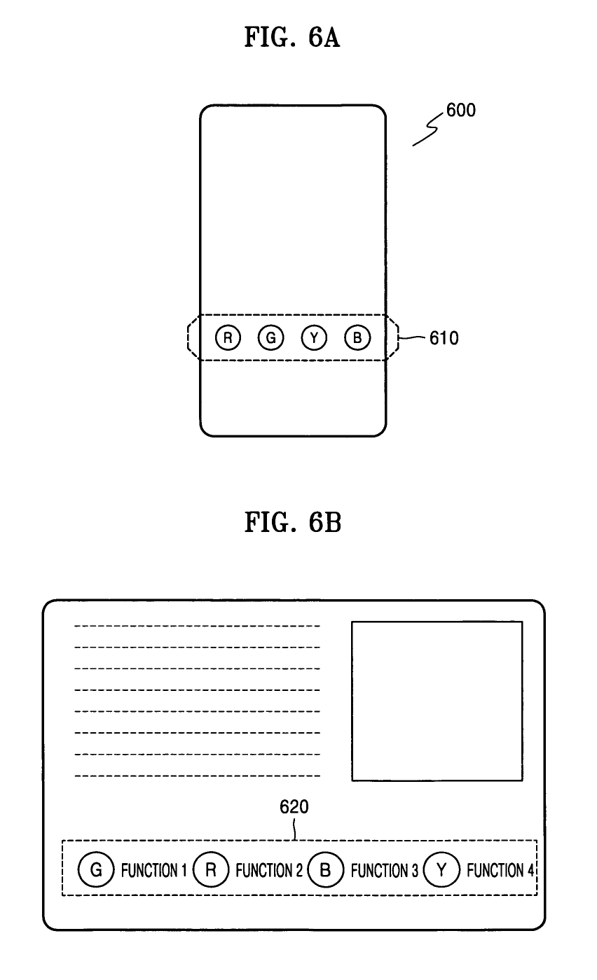

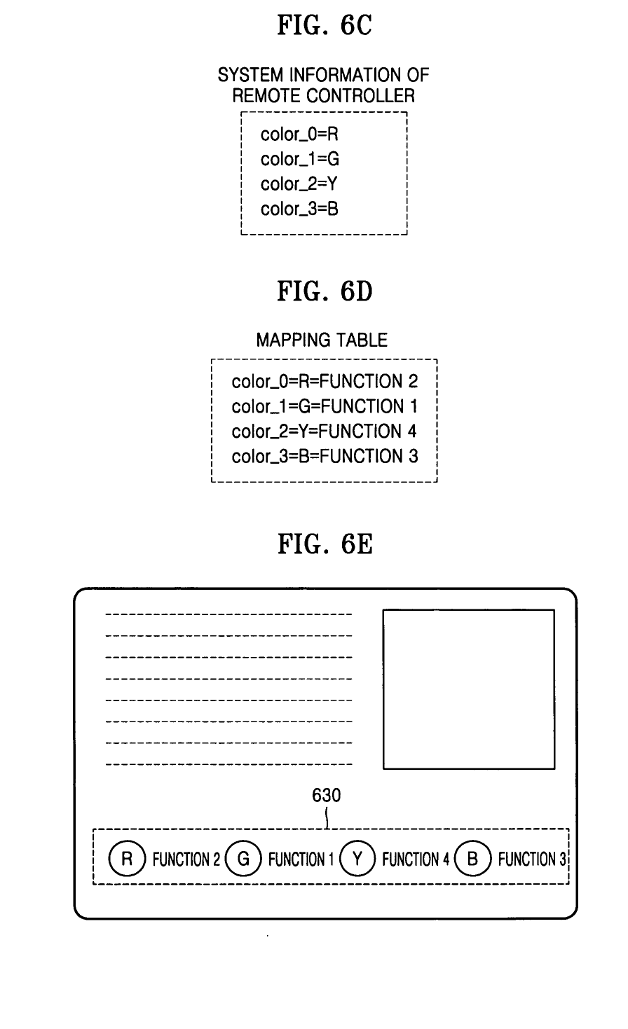

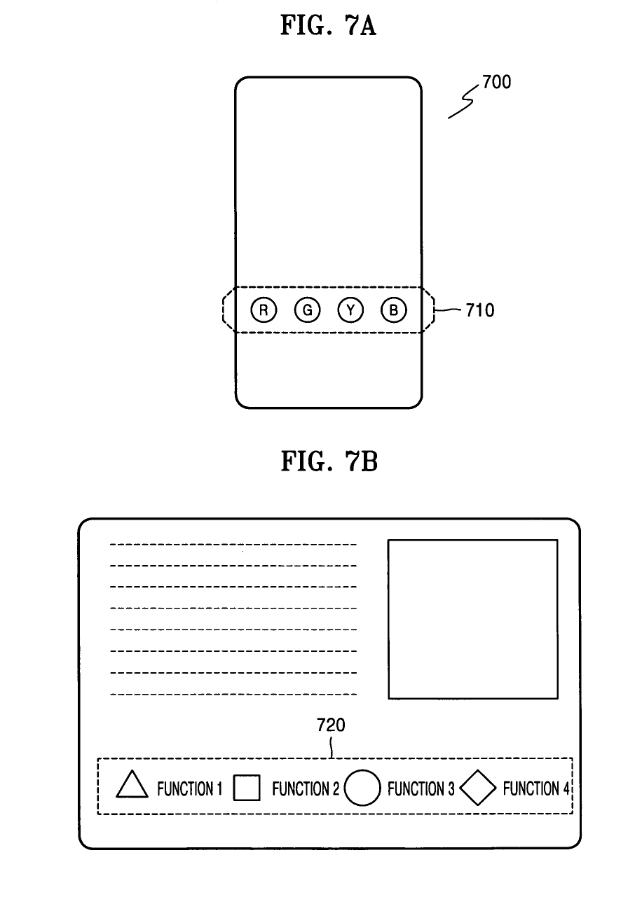

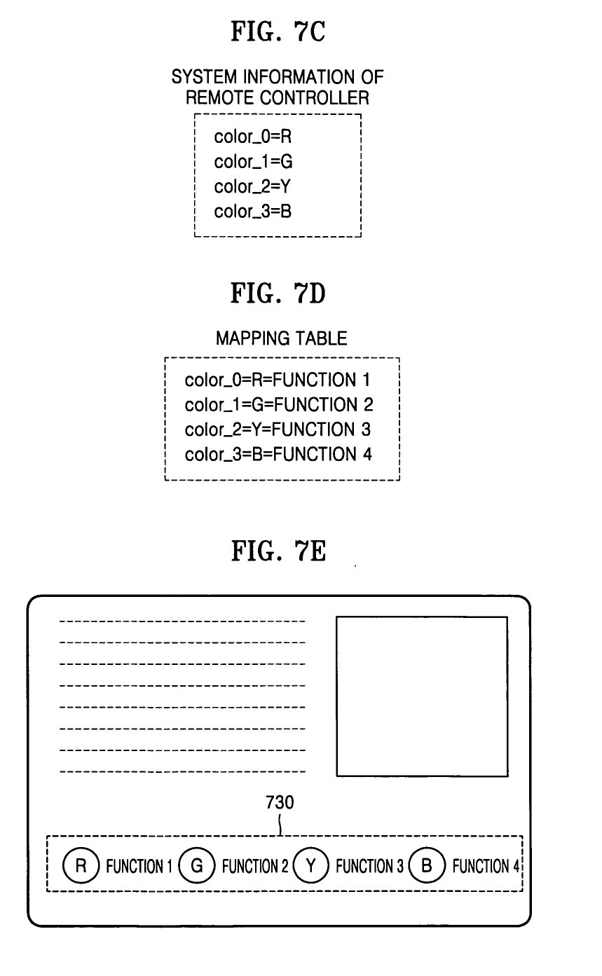

The reconstruction of the application contents includes: mapping the collected system information, that is, the arrangement information of the function keys of the remote controller 500, to the corresponding function keys of the application contents to thus create mapping information; and changing a user interface of the application contents so that a function key arrangement of the application contents displayed on a display unit is the same as a function key arrangement of the remote controller 500. A method of reconstructing application contents will be described in detail with reference to FIGS. 6A through 6E and FIGS. 7A through 7E below.

Then, the reconstructed application contents are executed.

The application contents execution unit 410 executes the reconstructed application contents and provides the result to the video reconstruction unit 360.

Hereinafter, a method of reconstructing application contents, according to an embodiment of the present invention, will be described with reference to FIGS. 6A through 6E.

FIG. 6A is an example in which color keys 610 are arranged in an order of R, G, Y and B on a remote controller 600 of a data broadcast receiver, and FIG. 6B is an example of original application contents received through the data broadcast receiver. Function keys 620 illustrated in FIG. 6B are arranged in an order of G, R, B and Y, and the function keys 620 respectively perform a function 1, a function 2, a function 3 and a function 4.

As such, since no mapping information exists between the color keys 610 of the remote controller 600 and the function keys 620 of the application contents displayed on the receiver, and the arrangement order of the color keys 610 is different from that of the function keys 620, users will experience confusion in matching the function keys 620 with the color keys 610 of the remote controller 600.

Accordingly, the application contents execution unit 410 according to the present invention extracts system information of the remote controller 600 as illustrated in FIG. 6C from the system information storage unit 420, and creates a mapping table as shown in FIG. 6D using the system information. Referring to FIG. 6D, since color_0 corresponds to Red in the system information and the Red key is corresponds to function 2 in the original application contents, mapping information “color_0=R=function 2” can be obtained. Since color_1 corresponds to Green in the system information and the Green key corresponds to function 1 in the original application contents, mapping information “color_1=G=function 1” can be obtained. Also, since color_2 corresponds to Yellow in the system information and the Yellow key corresponds to function 4 in the original application contents, mapping information “color_2=Y=function 4” can be obtained. Also, since color_3 corresponds to Blue in the system information and the Blue key corresponds to function 3 in the original application contents, mapping information “color_3=B=function 3” can be obtained.

By constructing the mapping table described above, when application contents are output on a screen, as illustrated in FIG. 6B, even when the color arrangement of color keys of a remote controller 600 is different from the color arrangement of function keys of the application contents, a user can execute his or her desired function by pressing a color key having the same color as the desired function key, intuitively considering that the color keys of the remote controller 600 correspond in color to the function keys of the application contents.

Also, by setting the arrangement order of function keys 630 of the application contents screen displayed on the display unit of the data broadcast receiver, according to the arrangement order of the color keys 610 of the remote controller 600, that is, in an order of R, G, Y and B, as illustrated in FIG. 6E, it is possible to further reduce user' confusion and increase user' convenience.

Hereinafter, a method of reconstructing application contents, according to another non-limiting embodiment of the present invention, will be described with reference to FIGS. 7A through 7E.

FIG. 7A is an example in which color keys 710 are arranged in an order of R, G, Y and B on a remote controller 700 of a data broadcast receiver, and FIG. 7B is an example of original application contents received through the data broadcast receiver. Function keys 720 of the application contents illustrated in FIG. 7B are arranged in an order of a triangle key, a square key, a circle key, and a diamond key according to their shapes, without being arranged according to their colors. The respective color keys 710 have marks indicating that the color keys 710 respectively perform a function 1, a function 2, a function 3 and a function 4.

As such, since no mapping information exists between the color keys 710 of the remote controller and the function keys 720 of the application contents displayed on the data broadcast receiver, and the attributes of the color keys 710 are different from those of the function keys 720, users will experience confusion about which function keys 720 correspond to which color keys 710 of the remote controller 700.

Accordingly, the application contents execution unit 410 of the data broadcast receiver 300 illustrated in FIG. 4 extracts system information, as shown in FIG. 7C, of the remote controller 700, from the system information storage unit 420, and creates a mapping table as shown in FIG. 7D using the system information. Referring to FIG. 7D, by obtaining information indicating that color_0 corresponds to Red from the system information and corresponds to function 1 of the original application contents, mapping information “color_0=R=function 1” can be obtained. Also, by obtaining information indicating that color_1 corresponds to Green from the system information and corresponds to function 2 of the original application contents, mapping information “color_1=G=function 2” can be obtained. Also, by obtaining information indicating that color_2 corresponds to Yellow from the system information and corresponds to function 3 of the original application contents, mapping information “color_2=Y=function 3” can be obtained. Also, by obtaining information indicating that color_3 corresponds to Blue from the system information and corresponds to function 4 of the original application contents, mapping information “color_3=B=function 4” can be obtained.

However, in the cases of FIGS. 7A and 7B, since the attributes of the color keys 710 are different from those of the function keys 720, users will have difficulty in intuitively determining which function keys 720 correspond to which color keys 710. Accordingly, it will be difficult to provide ease of convenience for users merely by mapping color keys of a remote controller to function keys of application contents. Therefore, in this case, as shown in FIG. 7E, it is preferable to change a user interface of application contents, so that the attributes of function keys 730 arranged on a screen of application contents displayed on a display unit of a data broadcast receiver correspond to the attributes of the color keys 710 arranged on the remote controller 700, and the function keys 730 are arranged and displayed in the same arrangement order as the color keys 710, that is, in an order of R, G, Y and B.

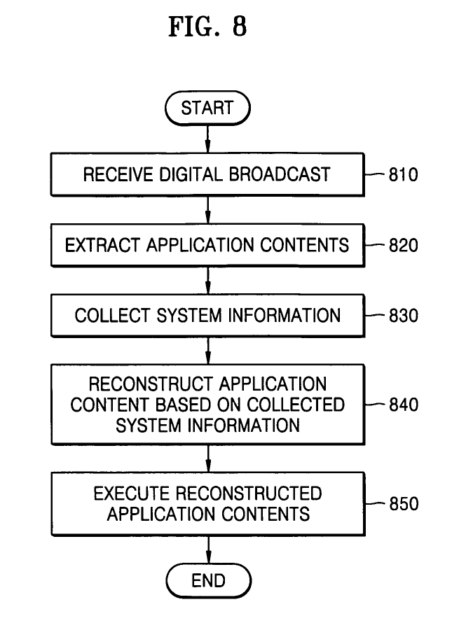

FIG. 8 is a flowchart illustrating a method of reconstructing application contents, according to a non-limiting embodiment of the present invention.

Referring to FIG. 8, a data broadcast receiver receives digital data (operation 810).

Then, a channel decoder of the data broadcast receiver extracts application contents from the digital data broadcast (operation 820).

A controller of the data broadcast receiver collects system information regarding color key arrangement, etc. of a remote controller (operation 830). The collection of the system information regarding the color key arrangement, etc. can be performed using a pre-defined class function or other methods.

Then, the controller reconstructs the application contents on the basis of the system information (operation 840). That is, mapping information is created by mapping information regarding color keys of the remote controller to information regarding function keys of the application contents, more preferably, a function key arrangement of the application contents is changed according to the color key information of the remote controller.

Then, the controller of the data broadcast receiver executes the application contents reconstructed as described above (operation 850).

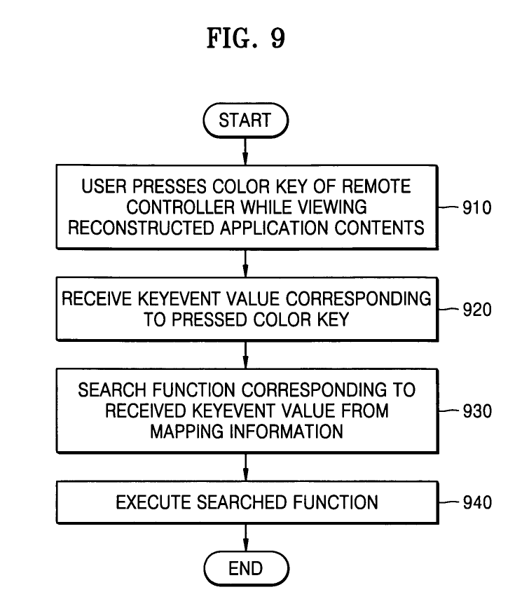

FIG. 9 is a flowchart illustrating a method of processing a desired function selected by a user when the reconstructed application contents are executed, according to a non-limiting embodiment of the present invention.

If application contents reconstructed using the method shown in FIG. 8 are suitable for display on the data broadcast receiver and are displayed on a display unit of the data broadcast receiver, a user presses a color key of a remote controller corresponding to a desired function to execute the desired function while viewing the reconstructed application contents (operation 910).

Then, a controller of the data broadcast receiver receives a KeyEvent value corresponding to the pressed color key (operation 920) and searches a function corresponding to the received KeyEvent value from mapping information (operation 930).

Then, the data broadcast receiver executes the searched function (operation 940).

The method of reconstructing and executing application contents, as described above, can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (transmission through the Internet). The computer readable recording medium can also be distributed over network coupled computer systems so that the computer readable code is stored and executed in a distributed fashion.

The functional program, codes, and code segments for executing the contents reconstruction and execution method can be easily deduced by programmers in the art.

As described above, according to the present invention, by dynamically reconstructing function key information of application contents to be executed in a receiver corresponding to a remote controller environment of the receiver, and changing a user interface of the application contents so that a function key arrangement of the application contents displayed on a display unit is the same as a function key arrangement of the remote controller, contents producers can provide application contents always having the same key format as that of a receiver to users to thus provide ease of convenience for users. Thus, users will have no difficulty in matching function keys with color keys of a remote controller.

While the present invention has been particularly shown and described with reference to exemplary, non-limiting embodiments thereof, it will be understood by those of ordinary skill in the art that various changes in form and details may be made therein without departing from the spirit and scope of the present invention as defined by the following claims.

What is claimed is:

1. A method of displaying data broadcast contents in a data broadcast receiver, comprising:
receiving application contents of a data broadcast;
obtaining system information of the data broadcast receiver;
reconstructing the application contents on the basis of the system information; and
displaying the reconstructed application contents.

2. The method of claim 1, wherein the system information comprises information regarding color keys or function keys of a remote controller for providing user input to the data broadcast receiver.

3. The method of claim 2, wherein the information regarding the color keys or the function keys comprises at least one of arrangement information, shape information, color information and sound information of the color keys or the function keys.

4. The method of claim 2, wherein the reconstruction of the application contents comprises: mapping the obtained information regarding the color keys or the function keys to information regarding a color key menu or a function key menu of the application contents.

5. The method of claim 4, wherein the reconstruction of the application contents further comprises: setting an arrangement of the color key menu or the function key menu of the application contents to be the same as an arrangement of the color keys or the function keys of the remote controller.

6. An apparatus of controlling display of data broadcast contents in a data broadcast receiver, comprising:
a memory operative to receive and store application contents of a data broadcast; and
a controller operative to load application contents stored in the memory, to obtain system information of the data broadcast receiver, to reconstruct the application contents on the basis of the system information, and to execute the reconstructed application contents.

7. The apparatus of claim 6, wherein the system information comprises information regarding color keys or function keys of a remote controller for providing user input to the data broadcast receiver.

8. The apparatus of claim 7, wherein the information regarding the color keys or the function keys comprises at least one of arrangement information, shape information, color information, and sound information of the color keys or the function keys.

9. The apparatus of claim 7, wherein the controller reconstructs the application contents by mapping the obtained information regarding the color keys or the function keys to information regarding a color key menu or a function key menu of the application contents.

10. The apparatus of claim 9, wherein the controller further sets an arrangement of the color key menu or the function key menu of the application contents to be the same as an arrangement of the color keys or the function keys of the remote controller.

11. A method of displaying data broadcast contents in a data broadcast receiver, comprising:
receiving a data broadcast signal;
extracting application contents from the data broadcast signal;
reconstructing the application contents on the basis of system information of the data broadcast receiver; and
displaying the reconstructed application contents.

12. The method of claim 11, wherein the reconstruction of the application contents comprises:
obtaining system information regarding color keys or function keys of a remote controller of the data broadcast receiver; and
mapping the system information to information regarding a color key menu or a function key menu of the application contents, and creating mapping information.

13. The method of claim 12, wherein the reconstruction of the application contents further comprises: changing a user interface of the application contents so that an arrangement of the color key menu or the function key menu of the application contents displayed on a display unit is the same as an arrangement of the color keys or the function keys of the remote controller.

14. The method of claim 12, further comprising executing a corresponding function using the mapping information if predetermined menu selection information for the reconstructed application contents is received from a user.

15. A data broadcast receiver, comprising:
a tuner operative to receive a data broadcast signal;
a channel decoder operative to extract application contents from the data broadcast signal received through the tuner;
a controller operative to reconstruct the application contents on the basis of system information of the data broadcast receiver; and
a video outputting unit operative to display the reconstructed application contents.

16. The data broadcast receiver of claim 15, wherein the controller obtains system information regarding color keys or function keys of a remote controller of the data broadcast receiver, and maps the system information to information regarding a color key menu or a function key menu of the application contents to thus create mapping information.

17. The data broadcast receiver of claim 16, wherein the controller changes a user interface of the application contents so that an arrangement of the color key menu or the function key menu of the application contents displayed on a display unit is the same as an arrangement of the color keys or the function keys of the remote controller.

18. The data broadcast receiver of claim 16, wherein if predetermined menu selection information of the reconstructed application contents is received from a user, the controller performs a corresponding function using the mapping information.
